(19) United States
(12) Patent Application Publication
(10) Pub. No.: US 2011/0084920 A1
(43) Pub. Date: Apr. 14, 2011

(54) REDUCING LAYERS IN A TOUCHPAD BY MAXIMIZING DISTANCE BETWEEN A GROUND PLANE AND SENSOR ELECTRODES ELECTRODES

(76) Inventors: Paul H. Glad, Taylorsville, UT (US); Steven M. Austin, Riverton, UT (US)

(21) Appl. No.: 12/815,130

(22) Filed: Jun. 14, 2010

Related U.S. Application Data
(60) Provisional application No. 61/186,790, filed on Jun. 12, 2009.

(51) Int. Cl. G06F 3/041; H01R 43/00

(52) U.S. Cl. 345/173; 29/825

(57) ABSTRACT

A system for reducing the number of layers of a touchpad between sensor electrodes that form a touch sensor, and the all other components of a touchpad, wherein the other components are comprised of a ground plane and sensor circuitry of a capacitance sensitive touchpad, and wherein the number of layers required for all the various components of the touchpad are reduced to thereby lower manufacturing costs of the touchpad.

### CROSS REFERENCE TO RELATED APPLICATIONS

This document claims priority to and incorporates by reference all of the subject matter included in the provisional patent application docket number 4620.CIRQ.PR, having Ser. No. 61/118,790.

### FIELD OF THE INVENTION

This invention relates generally to touchpads. More specifically, the present invention is a system for reducing the number of layers that are required for a capacitance sensitive touch sensor, or touch sensitive surface, when a so-called single layer touchpad is being manufactured, wherein the distance between a ground plane and sensor circuitry and the sensor electrodes is maximized to improve touchpad performance.

### DESCRIPTION OF RELATED ART

Hereinafter, references to a touchpad shall include all touch sensitive surfaces including touchpads and touch screens. There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

It is desirable to reduce the costs of manufacturing touchpads by placing as many components as possible on the same substrate layer of a touchpad. However, this can lead to problems when signals are attenuated because of the close proximity of electrodes and components to each other. Thus, it would be an advantage over the prior art top configure the layers of a capacitance sensitive touchpad so that interference and the total number of layers of a touchpad are minimized.

### BRIEF SUMMARY OF THE INVENTION

In a first embodiment, the present invention is a system for reducing interference between sensor electrodes that form a touch sensor, and the all other components of a touchpad, wherein the other components are comprised of a ground plane and sensor circuitry of a capacitance sensitive touchpad, and wherein the number of layers required for all the various components of the touchpad are reduced to thereby lower manufacturing costs of the touchpad.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

FIG. 2 is a profile view of the various layers of a touchpad that is constructed in accordance with the requirements of the first embodiment of the present invention.

FIG. 3 is a top view of a portion of the touch sensor showing a plurality of electrodes of the first and second electrode grids.

FIG. 4 is a profile view of the first and second electrode grids shown in FIG. 3.

FIG. 5 is a close-up profile view of a single junction of segments of single electrode of the second electrode grid and a single electrode of the first electrode grid, and showing a gap through the dielectric material to the segments of the second electrode grid.

FIG. 6 is a profile view as shown in FIG. 5 with the addition of a conductive path that electrically connects the segments of the single electrode of the second electrode grid.

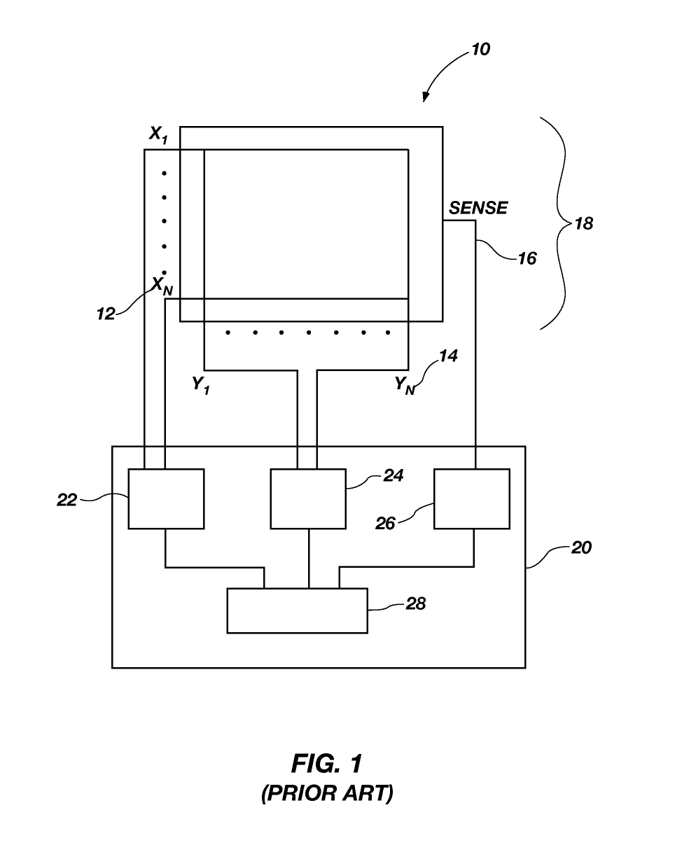

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The present invention accomplishes at least two purposes. First, it is desirable to use the fewest number of layers as possible when manufacturing a touchpad. Fewer layers means the overall costs of a touchpad are reduced. But while it is desirable to reduce the number of layers in a touchpad, a natural consequence is that touchpad components must necessarily be placed closer together. The result of components being in closer proximity is that signals can interfere with the operation of other components, or signals can be attenuated, and performance of the touchpad will suffer. Accordingly, a touchpad structure has been developed that addresses all of these concerns, and still reduces the total number of layers required by the touchpad.

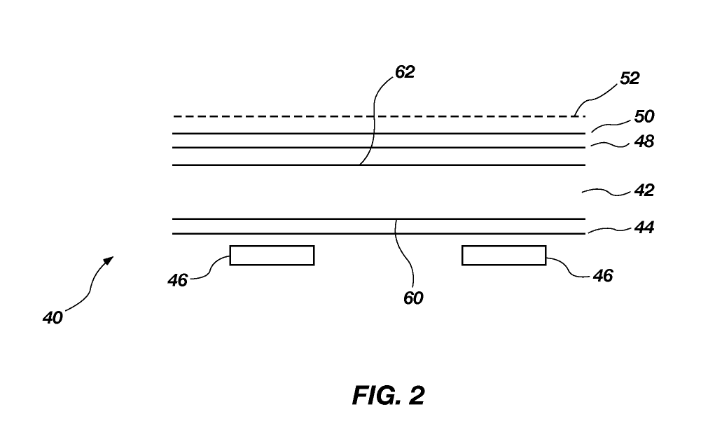

FIG. 2 is provided as a profile view of the components of a first embodiment of a capacitance sensitive touchpad that utilizes the improved structure of the present invention. In this figure, it is assumed that the touchpad 40 being manufactured is not one that is intended for use where a transparent substrate is needed. In other words, this touchpad is not used over a display screen such as an LCD display. This limitation is a result of the location of the sensor circuitry in this embodiment. Thus, the touchpad 40 is intended for those applications that require a touchpad that will not be used as a touchscreen or other application requiring visual transparency.

FIG. 2 shows the layers of the touchpad 40 of the present invention. The scale of the components shown should not be considered accurate but is instead exaggerated for illustration purposes only, and should not be considered a limitation of the claims to follow.

The touchpad 40 is comprised of a substrate 42 which is any substrate suitable for laying out sensor electrodes and sensor circuitry. Such a substrate can be created using a printed circuit board (PCB) material or any other similar material that does not interfere with operation of a capacitance sensitive touchpad.

On a first surface 60 of the substrate 42 is disposed a ground plane 44. The ground plane 44 may or may not cover the first surface 60 of the substrate 42 completely. For example, the ground plane 44 may be comprised of a grid, or it may be solid. Those skilled in the art of ground planes are familiar with the various designs and their functions. Any appropriate ground plane 44 may be used, and should not be considered to be a limiting factor of the design of the present invention.

Also disposed on the first surface 60 of the substrate 42 are sensor circuits 46. Sensor circuits receive input from sensor electrodes and determine the location of a finger or other object on the touchpad 40. The sensor circuits 46 should be considered to be electrically isolated from the ground plane 44 but also disposed on the first surface 60 of the substrate 42.

On a second surface 62 of the touchpad 40 that is opposite the first surface 60, sensor electrodes 48 are disposed thereon. The sensor electrodes 48 include X electrodes and Y electrodes as described previously. In an alternative embodiment, the sensor electrodes 48 may include a Sense electrode or electrodes.

The sensor electrodes 48 comprised of X and Y electrodes are a grid of orthogonally positioned electrodes that cross over each other at various locations, but do not make electrical contact.

FIG. 3 is an illustration of a first embodiment of a method for disposing the X and Y electrodes on the second surface 62 of the touchpad 40. Those skilled in the art will understand that there are different ways to dispose two orthogonally positioned and electrically isolated electrodes over each other. In FIG. 3, a top view is shown of a few electrodes of a first electrode grid 70. The first electrode grid 70 could be comprised of the X or the Y electrodes. Also shown are a few electrodes of the second electrode grid 72 that is positioned orthogonally to the first electrode grid 70. Now the second electrode grid 72 is repeatedly interrupted by the complete electrodes of the first electrode grid 70. In order to electrically couple the various segments of the second electrode grid 72, it will be necessary to add electrical connects that cross over the first electrode grid 70.

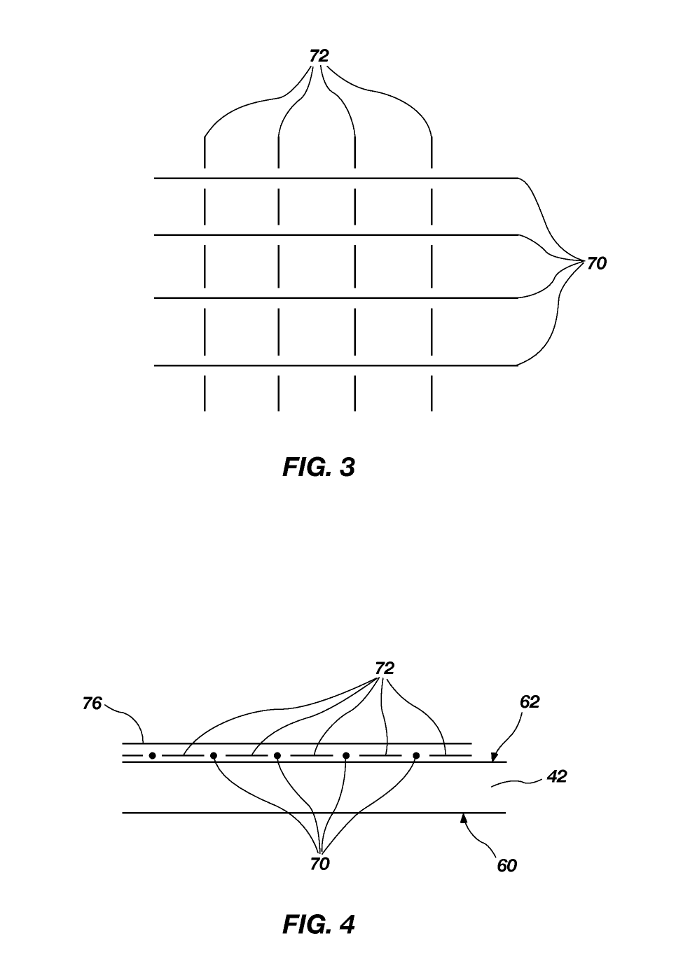

FIG. 4 is a profile view of the top view shown of the electrode grids 70 and 72 shown in FIG. 3. FIGS. 3 and 4 show that a dielectric material 76 is disposed over the first electrode grid 70 and the second electrode grid 72. In FIG. 4, the first electrode grid 70 is shown end-on, and thus perpendicular to the figure. Segments of a single electrode of the second electrode grid 72 are shown parallel to the figure.

Disposed on top of the first and second electrode grids 70, 72 is the dielectric material 76 which is illustrated in FIG. 4. In order to make electrical connections between the various segments of the electrodes that form the second electrode grid 72, it is necessary to make cuts through or to etch away a portion of the dielectric material 76.

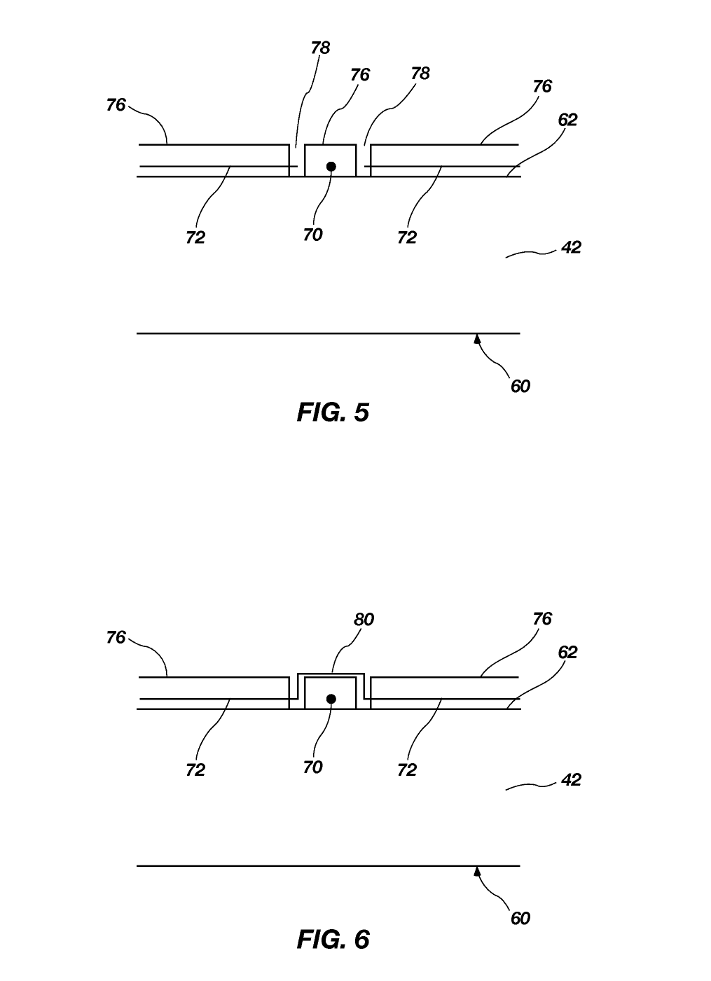

FIG. 5 is a close-up view of two segments of the second electrode grid 72 and a single electrode of the first electrode grid 70. FIG. 5 shows a gap 78 that has been created through the dielectric material 76. The gap 78 reaches all the way down to the segments of the second electrode grid 72 and exposes them so that an electrically conductive path can be created between the electrode segments.

FIG. 6 shows that a conductive path 80 is then made between the segments of the second electrode grid 72. The conductive path 80 goes over the dielectric material 76 and the first electrode grid 70 that is still covered thereby. The conductive path 80 is typically carbon ink or another conductive material that can be disposed on the dielectric material 76 of the touchpad 40.

The single junction shown in FIGS. 5 and 6 illustrates how the electrically isolated segments of the second electrode grid 72 are electrically coupled to each other by passing over an electrode of the first electrode grid 70. This cutting or etching of the dielectric material 76 at each junction of the first and second electrode grids 70, 72, and subsequent creation of a conductive path enables the use of a single substrate layer 42 in a capacitance sensitive touchpad 40.

An important aspect of the invention is that the thickness of the substrate 42 can be made as large as necessary. The thickness of substrate 42 might be adjusted, for example, to prevent interference of the sensor circuits 46 with the sensor electrodes 70, 72.

In a first alternative embodiment of the present invention, the ground plane 44 of the present invention is manufactured to minimize visual interference, using designs that are known to those skilled in the art. Furthermore, the sensor circuits 46 are not disposed on a portion of the first side 60 of the touchpad 40 that is opposite the location of the first and second electrode grids 70, 72. Thus, the present invention is capable of being used in a touch screen or with an LCD display.

In a second alternative embodiment of the present invention, the electrodes that are segmented are the electrodes of the first electrode grid. Alternatively, a combination of electrodes of the first and the second electrode grids are segmented and require conductive paths bet established at the junctions.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for reducing the number of layers of a capacitance sensitive touch sensor, said method comprising the steps of:
1) providing a substrate suitable for use with a capacitance sensitive touch sensor;
2) disposing a plurality of parallel electrodes of a first electrode grid on a second side of the substrate;
3) disposing a plurality of parallel electrodes of a second electrode grid that is orthogonal to the first electrode grid on the second side of the substrate, wherein the plurality of parallel electrodes overlap the first electrode grid without making electrical contact;
4) disposing a ground plane on a first side of the substrate; and
5) disposing sensor circuits on the first side of the substrate that are electrically connected to the first and second electrode grids on the second side of the substrate.

2. A method for reducing the number of layers of a capacitance sensitive touch sensor, said method comprising the steps of:
1) providing a substrate suitable for use with a capacitance sensitive touch sensor;
2) disposing a ground plane on a first side of the substrate;
3) disposing sensor circuits on the first side of the substrate;
4) disposing a plurality of parallel electrodes of a first electrode grid on a second side of the substrate;
5) disposing a plurality of parallel electrodes of a second electrode grid that is orthogonal to the first electrode grid on the second side of the substrate, wherein the plurality of parallel electrodes are segmented so as not to make contact with the first electrode grid;
6) disposing a dielectric material over the first and second electrode grids on the second side of the substrate;
7) making a plurality of gaps in the dielectric material at each junction where electrodes of the first electrode grid meet segments of electrodes of the second electrode grid, wherein the gaps only uncover a portion of electrodes of the second electrode grid; and
8) creating a conductive path between straight segments of the second electrode grid by disposing a conductive material over the dielectric material that is covering the first electrode grid at each junction.

3. A capacitance sensitive touch sensor that combines sensor electrodes on a same side of a substrate to thereby reduce the number of layers, said sensor comprised of:
a substrate suitable for use with a capacitance sensitive touch sensor;
a plurality of parallel electrodes of a first electrode grid disposed on a second side of the substrate;
a plurality of parallel electrodes of a second electrode grid that is orthogonal to the first electrode grid on the second side of the substrate, wherein the plurality of parallel electrodes overlap the first electrode grid without making electrical contact;
a ground plane on a first side of the substrate; and
sensor circuits disposed on the first side of the substrate that are electrically connected to the first and second electrode grids on the second side of the substrate.
